(19) United States
(12) Patent Application Publication
(10) Pub. No.: US 2023/0281896 A1
(43) Pub. Date: Sep. 7, 2023

(54) Unloading Steering Assist

(71) Applicant: AGCO International GmbH, Neuhausen (CH)

(72) Inventors: Martin Peter Christiansen, Randers (DK); Ramon Buchaca Tarragona, Randers (DK); Dan Hermann, Randers (DK); Morten Stigaard Laursen, Randers (DK); Esma Mujkic, Randers (DK); Morten Leth Bilde, Randers (DK)

(21) Appl. No.: 18/153,224

(22) Filed: Jan. 11, 2023

(30) Foreign Application Priority Data
Mar. 2, 2022 (GB) 2201421.1

(51) Int. Cl. G06T 11/20; B60R 1/22; A01D 90/10; G06V 20/58; G06T 7/70; H04N 7/18; G01F 23/284

(52) U.S. Cl. CPC G06T 11/206; B60R 1/22; A01D 90/10; G06V 20/58; G06T 7/70; H04N 7/183; G01F 23/284; G06T 2207/30204; G06T 2207/30252; G06T 2200/24

(57) ABSTRACT

An agricultural harvester includes a crop processor for reducing crop material to processed crop and an unload conveyor for transferring processed crop out of the agricultural harvester. One or more sensors generate data indicating a fill level of processed crop within a receiving vehicle. A camera generates image data including at least a portion of the receiving vehicle. A controller receives the data from the one or more sensors, determines the fill level of the processed crop in the grain bin of the receiving vehicle, receives the image data from the camera and generates a graphical indicator of the fill level. The graphical indicator includes a graphical depiction of the receiving vehicle from the image data and a graphical marker superimposed over at least a portion of the graphical depiction of the receiving vehicle. A graphical user interface presents the graphical indicator of the fill level to a user.

### RELATED APPLICATIONS

The present application claims priority under 35 U.S.C. § 119 to United Kingdom Patent Application No. 2201421.1, filed Feb. 3, 2022. The full disclosure, in its entirety, of United Kingdom Application No. 2201421.1 is hereby incorporated by reference.

### FIELD

Embodiments of the present invention relate to systems and methods for assisted synchronization of agricultural machine operations. More particularly, embodiments of the present invention relate to systems and methods for assisted synchronization of machine movement during transfer of crop material from one machine to another.

### BACKGROUND

Combine harvesters are used in agricultural production to cut or pick up crops such as wheat, corn, beans and milo from a field and process the crop to remove grain from stalks, leaves and other material other than grain (MOG). Processing the crop involves gathering the crop into a crop processor, threshing the crop to loosen the grain from the MOG, separating the grain from the MOG and cleaning the grain. The combine harvester stores the clean grain in a clean grain tank and discharges the MOG from the harvester onto the field. The cleaned grain remains in the clean grain tank until it is transferred out of the tank through an unload conveyor into a receiving vehicle, such as a grain truck or a grain wagon pulled by a tractor.

To avoid frequent stops during a harvesting operation it is common to unload the grain from a harvester while the combine harvester is in motion harvesting crop. Unloading the harvester while it is in motion requires a receiving vehicle to drive alongside the combine harvester during the unload operation. This requires the operator driving the receiving vehicle to align a grain bin of the receiving vehicle with the spout of an unload conveyor of the combine for the duration of the unload operation. Aligning the two vehicles in this manner is laborious for the operator of the receiving vehicle and, in some situations, can be particularly challenging. Some circumstances may limit the operator's visibility, for example, such as where there is excessive dust in the air around the receiving vehicle or at nighttime. Furthermore, if the receiving vehicle has a large or elongated grain bin, such as a large grain cart or a grain truck, it is desirable to shift the position of the grain bin relative to the spout during the unload operation to evenly fill the grain bin and avoid spilling grain. The operator of the receiving vehicle cannot see into the bin of the receiving vehicle from the operator's cabin and, therefore, must estimate the fill pattern of the receiving vehicle during the fill process and shift the position of the grain bin accordingly to try to fill the receiving vehicle evenly.

Forage harvesters also process crop but function differently from combine harvesters. Rather than separating grain from MOG, forage harvesters chop the entire plant—including grain and MOG—into small pieces for storage and feeding to livestock. Forage harvesters do not store the processed crop onboard the harvester during the harvest operation, but rather transfer the processed crop to a receiving vehicle by blowing the crop material through a discharge chute to the receiving vehicle, such as a silage wagon pulled by a tractor, without storing it on the harvester. Thus, a receiving vehicle must closely follow the forage harvester during the entire harvester operation. This presents similar challenges to those discussed above in relation to the combine harvester.

The above section provides background information related to the present disclosure which is not necessarily prior art.

### SUMMARY

A system according to a first embodiment comprises an agricultural harvester including a crop processor for reducing crop material to processed crop and an unload conveyor for transferring processed crop out of the agricultural harvester. The system further comprises one or more sensors for generating data indicating a fill level of processed crop within the grain bin of a receiving vehicle proximate the agricultural harvester, and a camera positioned to capture images of the receiving vehicle and configured to generate image data, the image data including image data of at least a portion of the receiving vehicle.

A controller is configured for receiving the data from the one or more sensors, determining, using the data from the one or more sensors, the fill level of the processed crop in the grain bin of the receiving vehicle, receiving the image data from the camera, generating a graphical indicator corresponding to the receiving vehicle, the graphical indicator including a graphical depiction of the receiving vehicle from the image data and a graphical marker superimposed over at least a portion of the graphical depiction of the receiving vehicle. A graphical user interface is in communication with the controller, the graphical user interface being configured to present the graphical indicator of the fill level to a user.

In some embodiments, the graphical marker includes a bar superimposed over the graphical depiction of the receiving vehicle, a height of the bar indicating the fill level of the receiving vehicle; the graphical marker may include a plurality of bars superimposed over the graphical depiction of the receiving vehicle, wherein a height of each of the plurality of bars indicates the fill level of the receiving vehicle at a different location in the receiving vehicle.

In some embodiments, the graphical marker includes a visual indicator of at least one of a grain bin of the receiving vehicle, an unload conveyor of the agricultural harvester, and a stream of crop flowing between the agricultural harvester and the receiving vehicle.

In some embodiments, the image data generated by the camera further includes image data of at least a portion of an unload conveyor of the agricultural harvester, and the graphical indicator generated by the controller further includes a depiction of at least a portion of the unload conveyor such that the graphical indicator includes the graphical depiction of the receiving vehicle from the image data, the graphical marker superimposed over at least a portion of the graphical depiction of the receiving vehicle, and the depiction of at least a portion of the unload conveyor.

A method according to another embodiment comprises using one or more sensors to generate data indicating a fill level of processed crop within a grain bin of a receiving vehicle proximate an agricultural harvester, the agricultural harvester including a crop processor for reducing crop material to processed crop and an unload conveyor for transferring processed crop out of the agricultural harvester. The method further comprises using a camera to generate image data, the image data including image data of at least a portion of the receiving vehicle; using a controller to determine, using the data from the one or more sensors, the fill level of the processed crop in the grain bin of the receiving vehicle; using the controller to generate a graphical indicator of the fill level, the graphical indicator including a graphical depiction of the receiving vehicle from the image data and a graphical marker superimposed over at least a portion of the graphical depiction of the receiving vehicle; and presenting the graphical indicator of the fill level on a graphical user interface, the graphical user interface being in communication with the controller and receiving the graphical indicator from the controller.

### DRAWINGS

Embodiments of the present invention are described in detail below with reference to the attached drawing figures, wherein:

FIG. 1 is an agricultural harvester constructed in accordance with an embodiment of the invention.

FIG. 2 illustrates the agricultural harvester of FIG. 1 and a receiving vehicle, with the agricultural harvester in position to transfer processed crop to the receiving vehicle.

FIG. 3 is a block diagram of an unload synchronization assistance system for use with the agricultural harvester and the receiving vehicle.

FIG. 4 is a diagram of certain components of a camera used on the agricultural harvester of FIG. 1.

FIG. 5 is a perspective view of the agricultural harvester and receiving vehicle of FIG. 2 illustrating a field of view of the camera of FIG. 4 when mounted on the harvester.

FIGS. 6-9 depiction images captured by the camera of FIG. 4 when mounted the harvester of FIG. 1.

FIG. 10 is a perspective view of the agricultural harvester and receiving vehicle of FIG. 2 illustrating a scan area of an electromagnetic detecting and ranging module on the agricultural harvester.

FIG. 11 illustrates data points collected by the electromagnetic detecting and ranging sensor of FIG. 10 when positioned over an empty receiving vehicle.

FIG. 12 illustrates data points collected by the electromagnetic detecting and ranging sensor of FIG. 10 when positioned over a partially filled receiving vehicle.

FIG. 13 illustrates a graphical user interface associated with a portable electronic device, the graphical user interface including at least a portion of an image captured by a camera on the agricultural harvester.

FIGS. 14-18 illustrate graphical indicators of the fill level of the receiving vehicle presented on the graphical user interface of FIG. 13.

FIG. 19 illustrates the graphical user interface of FIG. 13 with a grain bin of the receiving vehicle highlighted or otherwise visually indicated.

FIG. 20 illustrates the graphical user interface of FIG. 13 with a grain bin of the receiving vehicle and an unloading spout of the harvester both highlighted or otherwise visually indicated.

FIG. 21 illustrates the graphical user interface of FIG. 13 with a grain bin of the receiving vehicle, an unloading spout of the harvester and a stream of crop all highlighted or otherwise visually indicated, and further including a graphical indicator of the fill level of the receiving vehicle.

FIG. 22 is a block diagram of certain components of a portable electronic device.

FIG. 23 is a flow diagram of a method of identifying the grain bin of the receiving vehicle from an image using machine learning.

FIG. 24 illustrates an area of interest of the image of the receiving vehicle, wherein the area of interest is adjusted using the method of FIG. 23.

FIG. 25 is a block diagram of an unload synchronization assistance system for use with the agricultural harvester and the receiving vehicle.

The drawing figures do not limit the present invention to the specific embodiments disclosed and described herein. The drawings are not necessarily to scale, emphasis instead being placed upon clearly illustrating the principles of the invention.

### DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the spirit and scope of the invention as defined by the claims. The following description is, therefore, not to be taken in a limiting sense. Further, it will be appreciated that the claims are not necessarily limited to the particular embodiments set out in this description.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

When elements or components are referred to herein as being “connected” or “coupled,” the elements or components may be directly connected or coupled together or one or more intervening elements or components may also be present. In contrast, when elements or components are referred to as being “directly connected” or “directly coupled,” there are no intervening elements or components present.

Given the challenges of synchronizing the operation of harvesters and receiving vehicles during unload operations, as explained above, it is desirable to assist machine operators in manually controlling the machines to maintain the desired relative positions of the two machines. One method of assisting operation of at least one of the machines in this way involves using one or more sensors to detect a fill level and/or fill distribution of crop within a grain bin of a receiving vehicle and generating a graphical user interface indicating the fill level and/or the fill distribution of the crop within the grain bin of the receiving vehicle.

The graphical user interface includes a graphical depiction of the receiving vehicle with a graphical marker superimposed over at least a portion of the graphical depiction of the receiving vehicle, wherein the marker indicates the fill level. The marker may include a single bar whose height indicates a fill level, or may include multiple bars wherein the height of each bar indicates a fill level at a different location within the grain bin of the receiving vehicle. Using multiple bars to indicate the fill level at multiple distinct locations provides a visual indicator of the distribution of crop within the receiving vehicle. This graphical depiction of the receiving vehicle along with the graphical marker enables the operator of the receiving vehicle to immediately see the distribution of crop in the receiving vehicle and adjust the position of the receiving vehicle relative to the harvester, if necessary. The system updates the graphical user interface in real time or nearly in real time, thus addressing the challenge the operator faces of being aware of the fill level and/or distribution level of the receiving vehicle during operations in which crop is transferred from the harvester to the receiving vehicle.

A system according to a first embodiment of the invention comprises an agricultural harvester, one or more sensors, a camera, a controller and a graphical user interface. The agricultural harvester includes a crop processor for reducing crop material to processed crop and an unload conveyor for transferring processed crop out of the agricultural harvester. The one or more sensors generate data indicating a fill level of processed crop within the grain bin of a receiving vehicle proximate the agricultural harvester. The camera is positioned to capture images of the receiving vehicle and is configured to generate image data, the image data including image data of at least a portion of the receiving vehicle. The controller is configured to receive data from the one or more sensors, determine, using the data from the one or more sensors, the fill level of the processed crop in the grain bin of the receiving vehicle, receive the image data from the camera, and generate a graphical indicator of the fill level. The graphical indicator includes a graphical depiction of the receiving vehicle from the image data and a graphical marker superimposed over at least a portion of the graphical depiction of the receiving vehicle. The graphical user interface is in communication with the controller and is configured to present the graphical indicator of the fill level to a user.

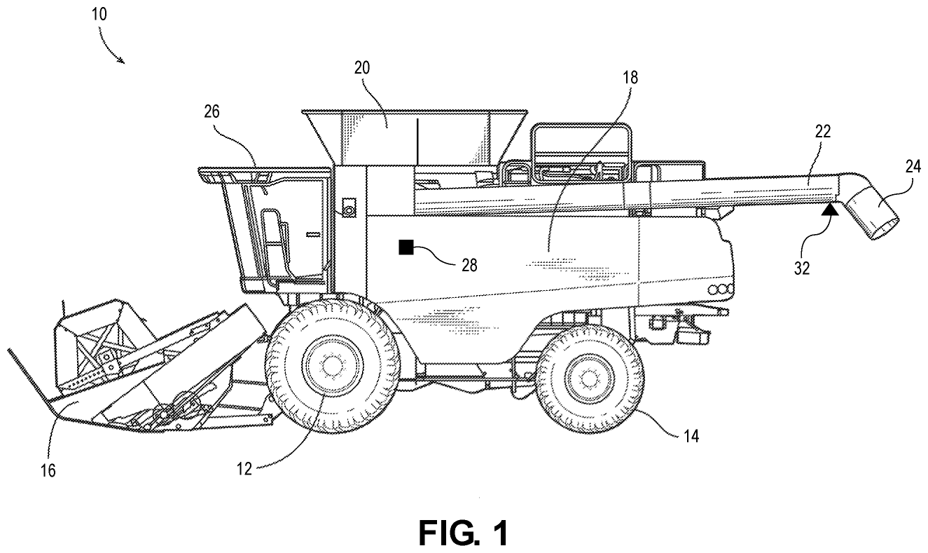

Turning now to the drawing figures, and initially FIGS. 1-3, an agricultural harvester 10 constructed in accordance with the first embodiment is illustrated. The harvester 10 is a combine harvester that cuts or picks up crop from a field, threshes the crop to loosen the grain from material other than grain (MOG), separates the grain from the MOG, cleans the grain, stores the clean grain in a clean grain tank and transfers the clean grain out of the clean grain tank to a receiving vehicle or other receptacle. The illustrated harvester 10 includes a pair of front wheels 12 and a pair of rear wheels 14 that support the harvester 10 on a ground surface, propel it along the ground surface and provide steering. A header 16 cuts crop standing in a field (or picks up crop that was previous cut) as the harvester 10 moves through the field and gathers the cut crop to be fed to a processor housed within a body 18 of the harvester 10.

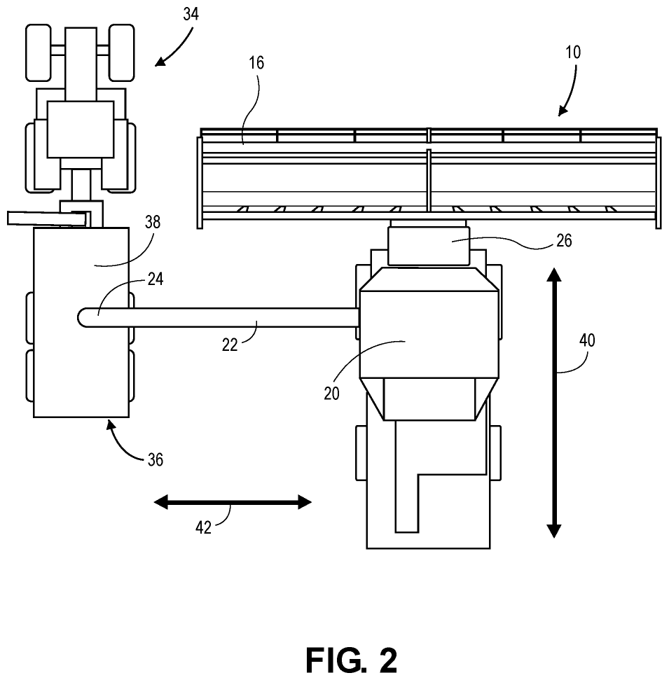

The processor threshes the grain, separates the grain from the MOG, cleans the grain and stores the grain in a clean grain tank 20. Thus, the processor reduces crop material (plants or portions of plants cut or picked up from the field) to processed crop (grain). An unload conveyor 22 transfers grain from the clean grain tank 20 to a receiving vehicle or other receptacle using one or more augers, belts or similar mechanisms to move grain out of the clean grain tank 20, through the unload conveyor 22 and out a spout 24 positioned at an end of the unload conveyor 22 distal the body 18 of the harvester 10. The unload conveyor 22 is illustrated in a stowed position in FIG. 1 used when the harvester 10 is not transferring grain out of the grain tank 20. The unload conveyor 22 is moveable between the stowed position and a deployed position, illustrated in FIG. 2, used to transfer grain from the grain tank 20 to a receiving vehicle or other receptacle. The receiving vehicle illustrated in FIG. 2 is a tractor 34 and grain cart 36 combination. The grain cart 36 includes a grain bin 38 for holding crop transferred out of the harvester 10. When the unload conveyor 22 is in the deployed position it is generally perpendicular to a longitudinal axis of the harvester 10, the longitudinal axis being parallel with line 40 in FIG. 2. When the unload conveyor 22 is in the fully stowed position (FIG. 1) it is generally parallel with the longitudinal axis of the harvester.

An operator cabin 26 includes a seat and a user interface for enabling an operator to control various aspects of the harvester 10. The user interface includes mechanical components, electronic components, or both such as, for example, knobs, switches, levers, buttons, dials as well as electronic touchscreen displays that both present information to the operator in graphical form and receive information from the operator. The harvester 10 includes a camera 28 mounted on an exterior surface 30 of the combine body 18. The camera 28 is configured and positioned for capturing images of an area proximate the agricultural harvester 10 and generates image data, as explained below. In the embodiment illustrated in FIG. 1, the camera 28 is mounted on the exterior surface 30 (being on the same side of the harvester 10 as the unload conveyor 22) between one meter and four meters from the ground. In another embodiment of the invention, the camera 28 is mounted on the surface 30 between one and one-half meters and three meters from the ground. It will be appreciated that the precise location of the camera 28 is not critical and that the camera 28 may be place in other, equally-preferred locations.

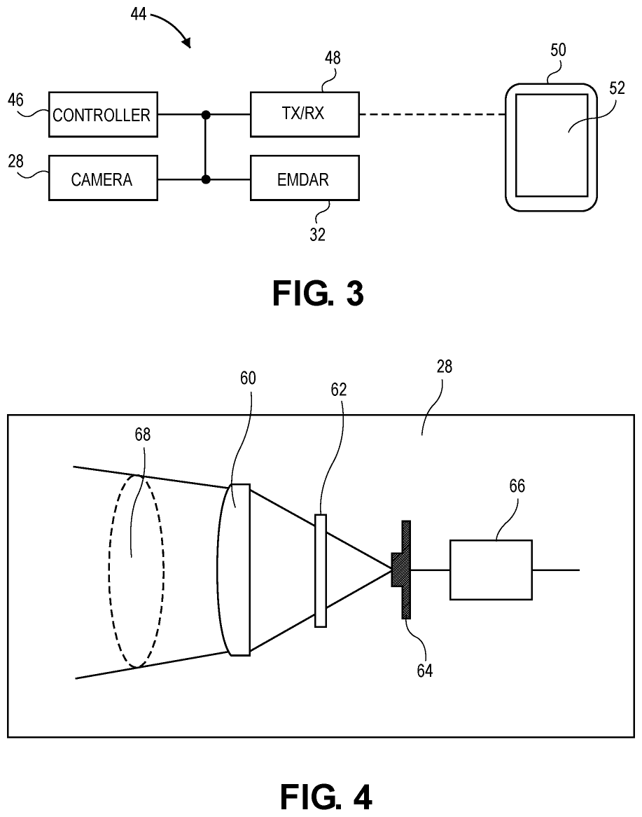

The harvester 10 further includes an electromagnetic detecting and ranging module 32 configured and positioned for detecting at least one of a fill level and a distribution of processed crop in the receiving vehicle. In the embodiment illustrated in FIG. 1, the electromagnetic detecting and ranging module 32 is positioned on the unload conveyor 22 and, more particularly, is positioned at or near an end of the unload conveyor 22 distal the body 18 of the combine 10. The camera 28 and the electromagnetic detecting and ranging module 32 are part of an unload synchronization assistance system 44 illustrated in FIG. 3.

The unload synchronization assistance system 44 assists an operator of the receiving vehicle, an operator of the harvester 10, or both during the grain unloading process by providing the operator with information about the relative positions of the receiving vehicle and the harvester 10 as well as a fill level, a distribution pattern, or both of crop material inside the receiving vehicle. The system 44 broadly includes a controller 46, the camera 28, the electromagnetic detecting and ranging module 32, a wireless transceiver 48 and a portable electronic device 50 including a graphical user interface portion 52.

The controller 46 is a computing device and includes one or more integrated circuits programmed or configured to implement the functions described herein. By way of example the controller 46 may be a digital controller and may include one or more general purpose microprocessors or microcontrollers, programmable logic devices, application specific integrated circuits or other computing devices. The controller 46 may include multiple computing components, such as electronic control units, placed in various different locations on the harvester. The controller 46 may also include one or more discrete and/or analog circuit components operating in conjunction with the one or more integrated circuits or computing components. Furthermore, the controller 46 may include or have access to one or more memory elements operable to store executable instructions, data, or both. The storage component 46 stores data and preferably includes a non-volatile storage medium such as solid state, optic or magnetic technology.

The wireless transceiver 48 is configured to communicate with the portable electronic device 50 using wireless communications technology. The wireless transceiver 48 may be configured to communicate according to one or more wireless communications protocols or standards, such as one or more protocols based on the IEEE 802.11 family of standards (“Wi-Fi”), the Bluetooth wireless communications standard, and/or a 433 MHz wireless communications protocol. Alternatively or additionally, the wireless transceiver 48 may be configured to communicate according to one or more proprietary or non-standardized wireless communication technologies or protocols, such as proprietary wireless communications protocols using 2.4 GHz or 5 GHz radio signals. Although illustrated in the diagram of FIG. 3 as a separate component, the wireless transceiver 48 may be physically integrated into the controller 46. Therefore, reference may be made herein to the controller 46 sending or receiving a wireless signal with the understanding that the controller 46 is using the wireless transceiver 48 to send or receive the signal, whether the controller 46 and the wireless transceiver 48 are part of the same physical component or separate components.

The camera 28 is positioned and configured for capturing images of objects that are proximate the harvester 10. The camera 28 is located on the exterior side surface 30 of the body 18 of the harvester 10, as explained above, and has a field of view extending outwardly from the side surface 30 and with a center of the field of view being perpendicular or approximately perpendicular to the longitudinal axis of the harvester 10. In this configuration the camera's field of view corresponds to an area in which a receiving vehicle is located during crop transfer operations.

A diagram of certain components of the camera 28 is illustrated in FIG. 4 and includes one or more lenses 60, an optional filter 62, a detector 64, and processing circuitry 66. The one or more lenses 60 collect and direct light from a field of view 68 through the filter 62 to the detector 64 and serve to focus and/or magnify images. The filter 62 passes select spectral bands such as ultraviolet, infrared or other bands. In some embodiments the camera 28 does not have a filter 62. The detector 64 is a digital image sensor that converts electromagnetic energy to an electric signal and employs image sensing technology such as charge-coupled device (CCD) technology and/or complementary metal oxide semiconductor (CMOS) technology. The processing circuitry 66 includes circuitry for amplifying and processing the electric signal generated by the detector 64 to generated image data, which is passed to the one or more computing devices such as the controller 46. The camera 28 includes an enclosure to house and protect the other components from exposure to weather and other harsh conditions associated with harvesting operations.

The electromagnetic detecting and ranging module 32 uses reflected electromagnet waves to generate a digital representation of objects within a field of view of the module. More particularly, the module 32 includes an emitter for emitting electromagnetic waves and a sensor for detecting reflected waves. Data generated by the sensor includes such information as an angle and a distance for each data point that indicate a point in space where the wave encountered and reflected off of an external object in the module's field of view. Thus, the digital representations generated by the module 32 include distances to and relative locations of objects and surfaces within the field of view. Technologies that may be used in the module 32 include LiDAR and RADAR.

Light detecting and ranging (LiDAR) is a method for measuring distances (ranging) by illuminating the target with laser light and measuring the reflection with a sensor. Differences in laser return times and wavelengths can then be used to make digital three-dimensional or two-dimensional representations of the area scanned. LiDAR may use ultraviolet, visible, or near infrared light to image objects and can target a wide range of materials, including metallic and non-metallic objects.

Radio detecting and ranging (RADAR) is a detection system that uses radio waves to determine the range, angle, and/or velocity of objects. A RADAR system includes a transmitter producing electromagnetic waves in the radio or microwave domains, a transmitting antenna, a receiving antenna (often the same antenna is used for transmitting and receiving) and a receiver and processor to determine properties of the object(s) within the scan zone of the system. Radio waves (pulsed or continuous) from the transmitter reflect off the object and return to the receiver, giving information about the object's location, direction of travel and speed.

The electromagnetic detecting and ranging module 32 collects data that define a digital representation of the area within the field of view of the module 32 and communicate that data to the controller 46. The data collected by the module 32 includes location information for each of a plurality of points making up a point cloud. The location information is relative to the module 32 and may include a set of two-dimensional Cartesian coordinates, such as X and Y coordinates of the point relative to the module 32; a set of three-dimensional Cartesian coordinates such as X, Y and Z coordinates; a set of polar coordinates such as a radial coordinate (r) indicating a distance from the module 32 and an angular coordinate (θ) indicating an angle from a reference direction; a set of spherical coordinates such as a radial coordinate (r) indicating a distance of the point from the module 32, a polar angle coordinate (θ) measured from a fixed zenith direction, and an azimuthal angle coordinate (φ) of its orthogonal projection on a reference plane that passes through the origin and is orthogonal to the zenith, measured from a fixed reference direction on that plane; or a set of cylindrical coordinates such as a distance (r) to the point from a reference axis (typically corresponding to a location of the module 32), a direction (φ) from the reference axis, and a distance (Z) from a reference plane that is perpendicular to the reference axis.

The portable electronic device 50 includes a user interface 52 for presenting graphical representations of the relative locations of the agricultural harvester 10 and the receiving vehicle, as well as the fill level, fill pattern, or both of crop material in the receiving vehicle. In the illustrated embodiment the portable electronic device 50 is a tablet computer, but it will be appreciated by those skilled in the art that it could be a smartphone or similar device capable of communicating wirelessly with the transceiver 48 to receive a wireless signal including location information and crop information and generating the graphical representations on the user interface 52. The portable electronic device 50 is discussed in greater detail below.

It will be appreciated that, for simplicity, certain elements and components of the system 44 have been omitted from the present discussion and from the diagram illustrated in FIG. 3. A power source or power connector is also associated with the system 44, for example, but is conventional in nature and, therefore, is not described herein.

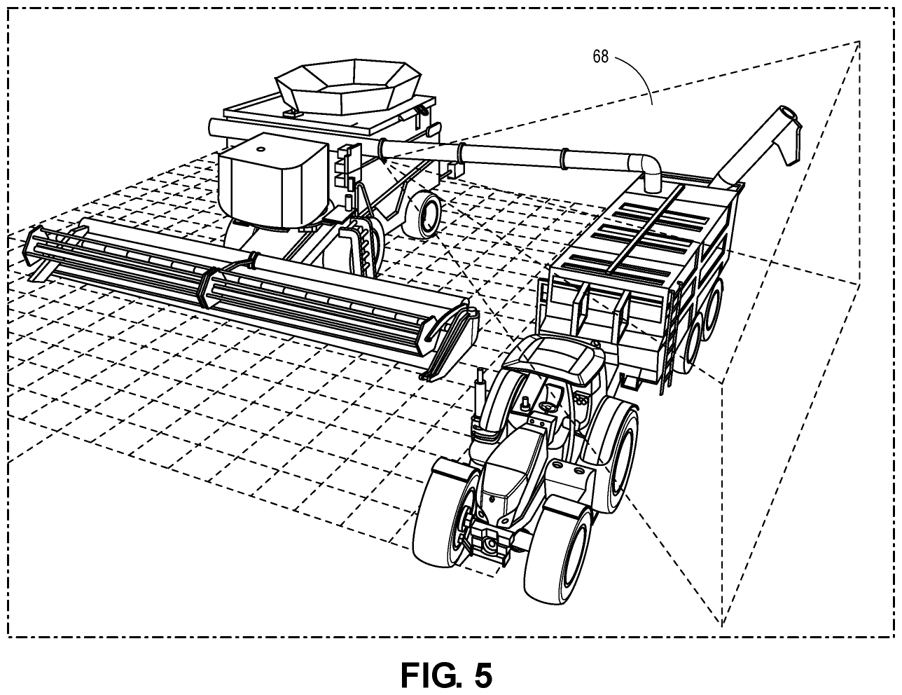

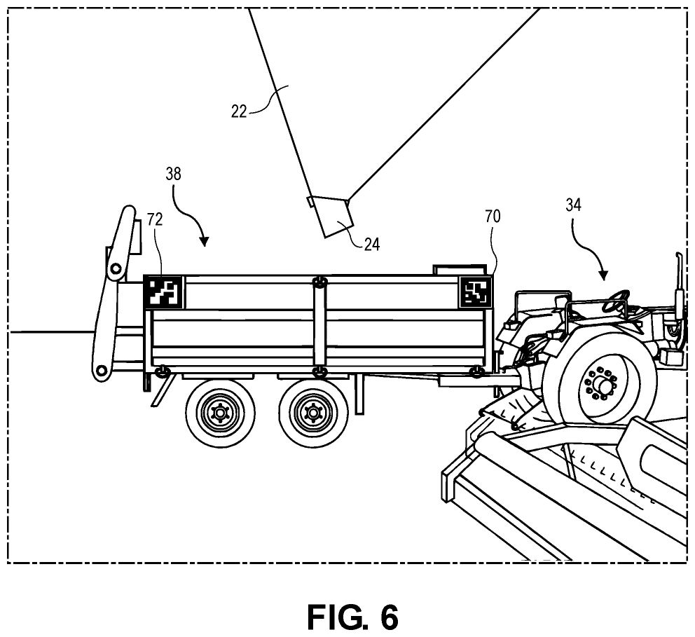

FIG. 5 illustrates the field of view 68 of the camera 28 relative to the harvester 10, tractor and grain cart. An exemplary image taken from the camera 28 is illustrated in FIG. 6 and includes the tractor 34 and grain cart 36. The unload conveyor 22 and spout 24 are also visible in the image. A first marker 70 and a second marker 72 are on a side of the grain cart 36 facing the camera 28 and are used by the controller to determine the location of the grain cart 36 relative to the agricultural harvester 10. The controller may also use the markers 70, 72 to determine the orientation and/or size of the grain cart 36.

The first marker 70 is located at or near an upper front corner of the grain cart 36 and the second marker 72 is located at or near an upper rear corner of the grain cart 36. The markers 70, 72 contain a predetermined visual pattern or design that is included in images captured by the camera 28 and used by the one or more computing devices to recognize the markers 70, 72. The controller searches for and recognizes the markers 70, 72 and uses the location and size of the markers to determine information about the grain cart 36 including the location of the grain cart 36 relative to the agricultural harvester 10, the orientation of the grain cart 36 relative to the agricultural harvester 10 and the size of the grain cart 36.

The controller uses the size of the markers 70, 72 and the location of the markers 70, 72 in the image captured by the camera 28 to determine the location of the grain cart 36. The size of the markers 70, 72 in the image, such as the number of pixels corresponding to the width, the height and/or the area of the markers 70, 72, is used to determine a distance of each marker 70, 72 from the camera 28. Given that the actual size of the markers 70, 72 is fixed and known the distance of each marker can be correlated with the size of the marker in the image by, for example, using a lookup table to assign a distance to a size of the image in the marker. The controller uses the distance of the markers 70, 72 to the camera 28 to determine the lateral separation of the grain cart 36 from the harvester 10 or, in other words, the distance between the harvester 10 and the grain cart 36 along the direction 42 illustrated in FIG. 2.

The controller also uses the locations of the markers 70, 72 in the image to determine whether the grain cart 36 is behind, in front of or even with the unload conveyor 22 or, in other words, the position of the grain cart 36 relative to the unload conveyor 22 along the direction 40 illustrated in FIG. 2. In the image illustrated in FIG. 6 the grain cart 36 is approximately centered beneath the unload conveyor 22. If the grain cart 36 were further to the left in the image it would be behind the unload conveyor 22 and if it were further to the right in the image it would be in front of the unload conveyor 22. Thus, the sizes of the markers 70, 72 are used to determine the lateral (side-to-side) position of the grain cart 36 relative to the unload conveyor 22 (along direction 82) and the locations of the markers 70, 72 left to right in the image are used to determine the longitudinal (front-to-back) position of the grain cart 36 relative to the conveyor 22 (along direction 40).

The first marker 70 is located at or near a top front corner of the grain cart 36 and the second marker is located at or near a rear top corner of the grain cart 36. This enables the controller to determine the size of the grain cart 36 using the distance of the markers 70, 72 from the camera 28 (determined by the size of the markers) and the distance between the markers 70, 72 (determine by the size and separation of the markers in the image). Both the location and size of the grain cart 36 may be used to generate a graphical representation of the relative positions of the unload conveyor 22 and the grain cart 36.

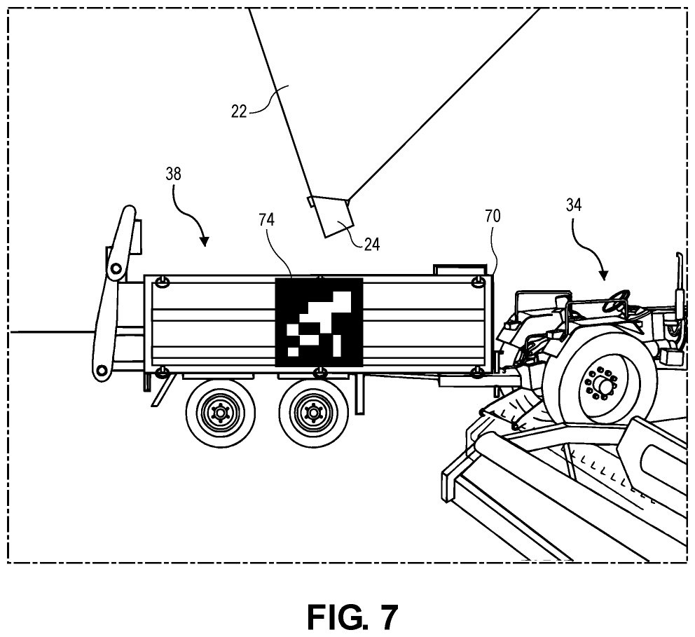

FIG. 7 illustrates another embodiment that includes a single visual marker 74 instead of two. The embodiment illustrated in FIG. 7 operates under the same principles as the embodiment using two markers except that when using a single marker the length of the grain cart 36 is not determined from the size of the marker.

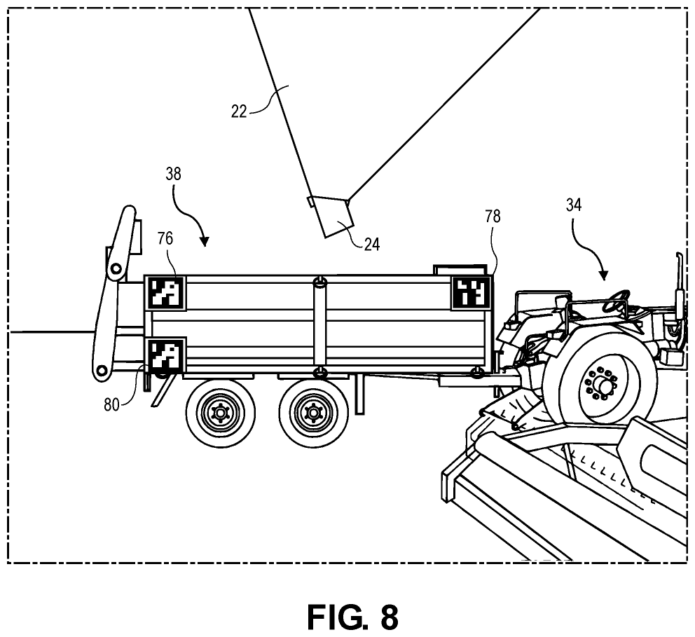

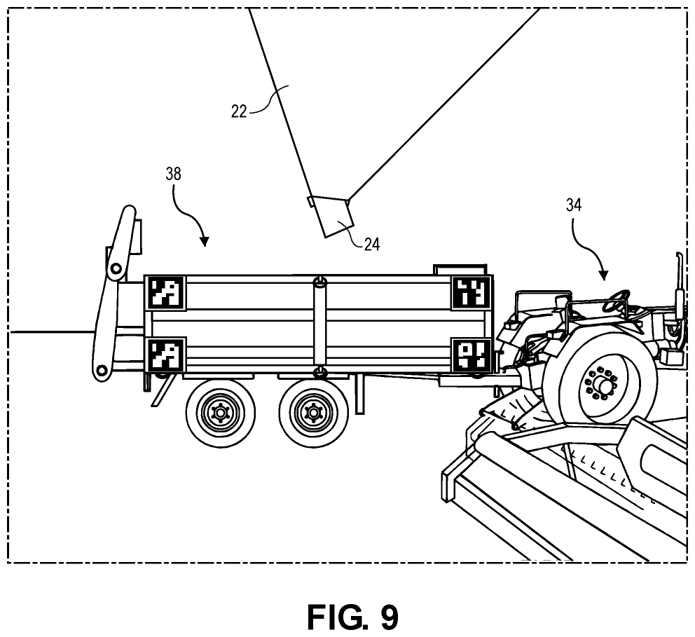

FIG. 8 illustrates another embodiment that includes three visual markers 76, 78, 80 instead of two. The embodiment illustrated in FIG. 8 operates under the same principles as the embodiment using two markers, described above, except that using the three markers 76, 78, 80 three corners of the grain cart 36 can be identified and used to determine the size and position of the grain cart 36 relative to the agricultural harvester 10. FIG. 9 illustrates another embodiment that includes four visual markers. The embodiment illustrated in FIG. 9 operates under the same principles as the embodiment using two markers, described above, except that using the four markers four corners of the grain cart 36 can be identified and used to determine the size and position of the grain cart 36 relative to the agricultural harvester 10.

The markers 70, 72, 74, 76, 78, 80 may be permanently affixed to the grain cart 36 (or other receiving vehicle) or may be temporarily attached thereto using bolts, clamps, magnets or other fasteners. An advantage to temporarily attaching the markers to the receiving vehicle is that they can be quickly and easily removed from one receiving vehicle and attached to another.

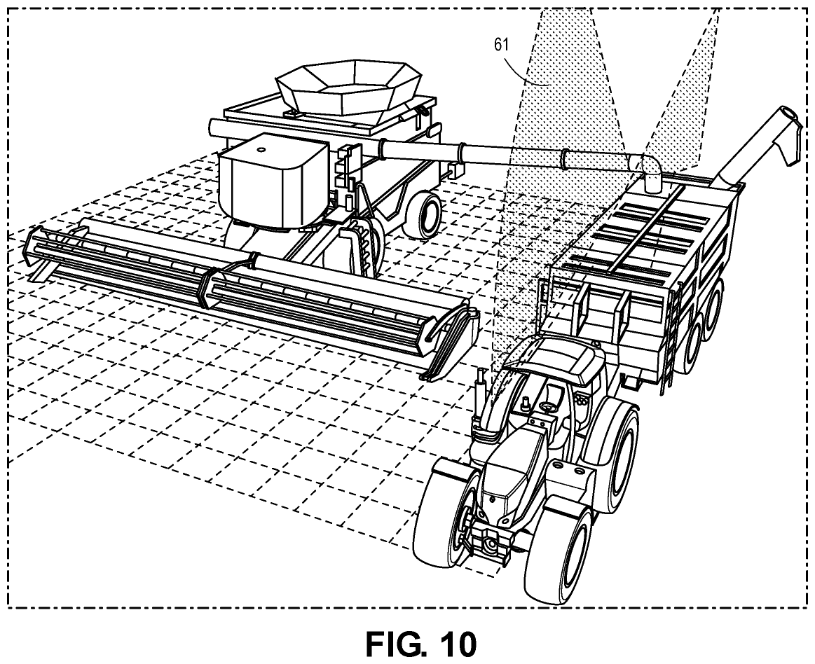

The electromagnetic detecting and ranging module 32 is located at or near an end of the unload conveyor 22 corresponding to the spout 24 and distal the body 18 of the harvester 10. The module 32 includes a scanner positioned to scan an area extending downwardly from the end of the unload conveyor 22 that is perpendicular or approximately perpendicular to a longitudinal axis of the unload conveyor 22. This scan area includes an area inside the grain bin 38 of the receiving vehicle when the grain bin 38 is positioned below the spout 24 of the unload conveyor 22. FIG. 10 illustrates a scan area 61 of the module 32 with a grain cart within the scan area.

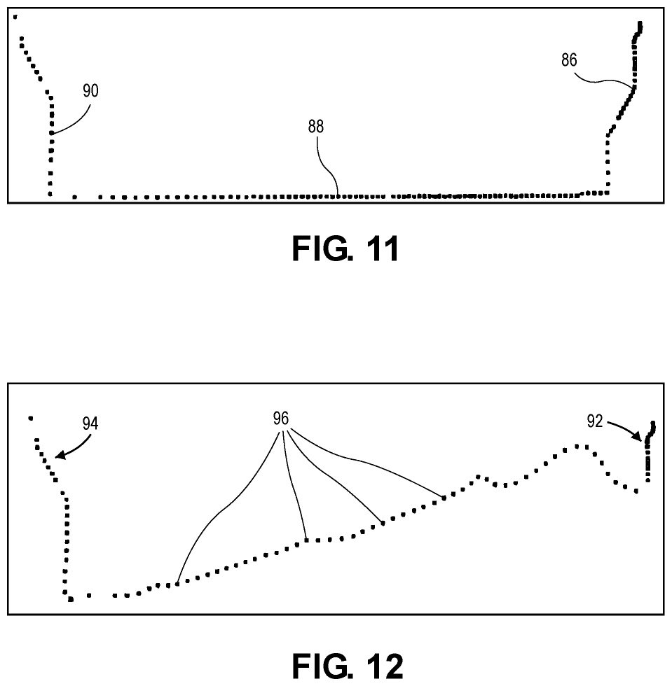

The module 32 includes a scanner that generates a plurality of data points within the plane corresponding to the scan area 61, each data point including a distance value corresponding to a distance from the module 32. The controller processes the data from the module 32 to identify patterns. A series of data points generated by the module 32 when the grain bin of the receiving vehicle is empty is illustrated in FIG. 11. A first pattern 86 of the data points corresponds to an interior surface of a front wall of the grain bin, a second pattern 88 corresponds to an interior surface of a floor of the grain bin and a third pattern 90 corresponds to an interior surface of a rear wall of the grain bin. A series of data points generated by the module 32 when the grain bin is partially filled is illustrated in FIG. 12. In FIG. 12 the generally vertical patterns near the front 92 and the near the rear 94 of the data set correspond to the front and rear walls of the grain bin while the data points 96 corresponding to the generally diagonal angled and curved patterns between the front and rear walls correspond to a top surface of a quantity of crop material heaped in the grain bin.

The controller 46 uses the data generated by the module 32 to determine the fill level of the grain cart 36, the distribution of grain (or other processed crop material) within the grain cart 36, or both. To determine the fill level of the grain cart 36 the controller identifies data points 96 corresponding to grain (verses data points corresponding to walls or the floor of the grain bin), determine a fill height of each of the data points corresponding to grain, and then average the fill height of the data points corresponding to grain to generate an average fill level of the grain bin. The fill height of the various data points corresponds to the distribution of grain.

To identify data points corresponding to grain the controller uses patterns in the data, receiving vehicle location information generated using data from the module 28, or both. The controller uses patterns in the data by identifying patterns corresponding to certain parts of the grain bin such as a front wall (for example, pattern 92), rear wall (for example, pattern 94) and floor (for example, pattern 88) or a combination of two or more of these features. In the collection of data illustrated in FIG. 11, for example, the walls and floor are identified from the data patterns 86, 88, 90 and it is determined that none of the data points correspond to grain. In the collection of data illustrated in FIG. 12, the front wall and the rear wall are identified from the data patterns 92 and 94. When the data patterns detected in FIG. 12 are compared to a data pattern corresponding to an empty grain bin (FIG. 11) it is determined that most of the data points between the front wall and the rear wall do not match the expected location and shape of a data pattern corresponding to the floor and, therefore, correspond to grain. The controller then determines a fill height of each of the data points corresponding to grain, wherein the fill height is the distance of the data point from the floor of the grain bin to the data point. The fill height is determined, for example, by comparing the location of the data point to the anticipated location of the floor. In the illustrated data patterns, this may involve comparing the data points 96 to data points 88. Once the fill height is determined for all of the data points an average fill height of all of the data points is determined and used as the overall grain bin fill level, as stated above.

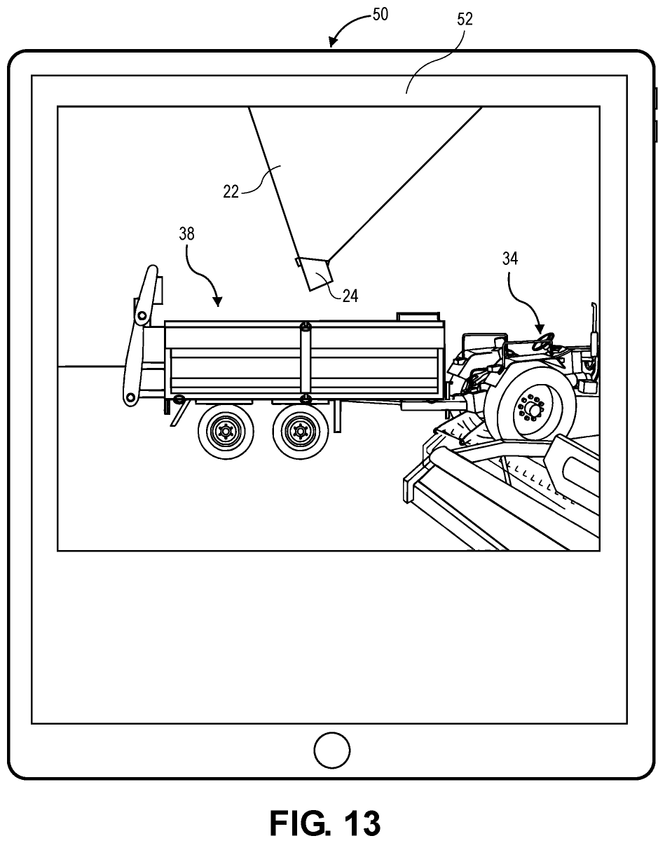

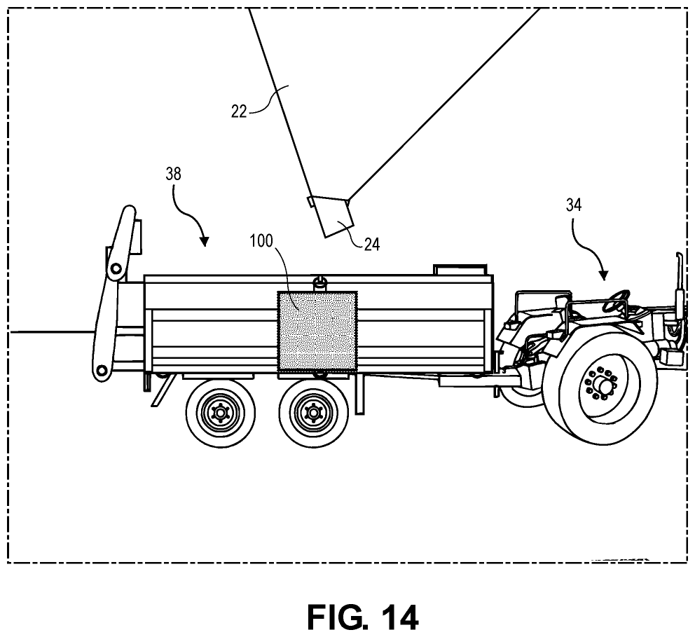

The graphical representation is presented as part of the graphical user interface portion 52 on the portable electronic device 50, illustrated in FIG. 13. The graphical representation of the grain cart 36, the harvester 10 and their relative positions enables the operator of the tractor 34 to guide the tractor to a location relative to the harvester 10 where the grain bin of the grain cart 36 is properly aligned with the unload auger 22. FIGS. 14 through 18 depict a portion of the graphical user interface of the device 50 wherein the graphical user interface includes a graphical indicator of the fill level, the graphical indicator including a graphical depiction of the receiving vehicle from image data generated by the camera 28 and a graphical marker superimposed over at least a portion of the graphical depiction of the receiving vehicle.

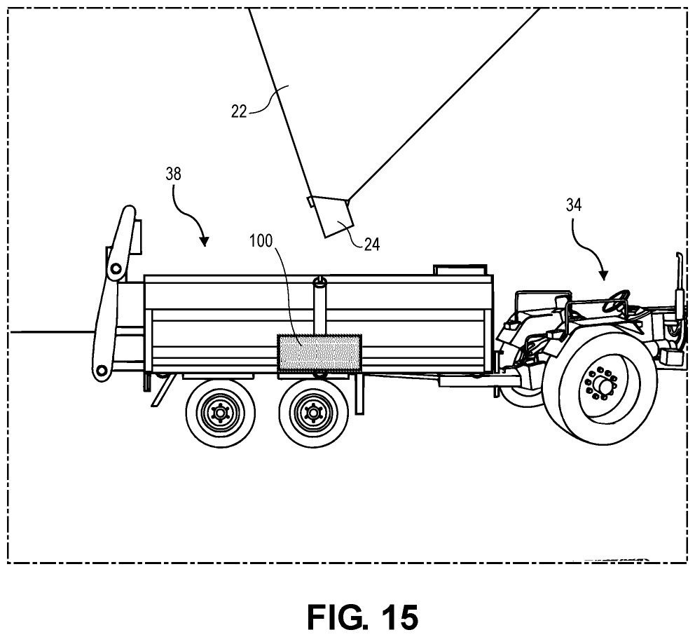

The graphical indicator depicted in FIGS. 14 and 15 includes the image of the receiving vehicle captured by the camera 28. The graphical indicator further includes a graphical bar 100 superimposed over the grain cart 36 wherein the height of the bar 100 indicates a fill level of the grain cart. Thus, an operator of the tractor 34 can see, from the image presented on the device, the fill level of the grain cart. In the image depicted in FIG. 14 the grain cart is nearly full, wherein in the image depicted in FIG. 15 the grain cart is nearly empty.

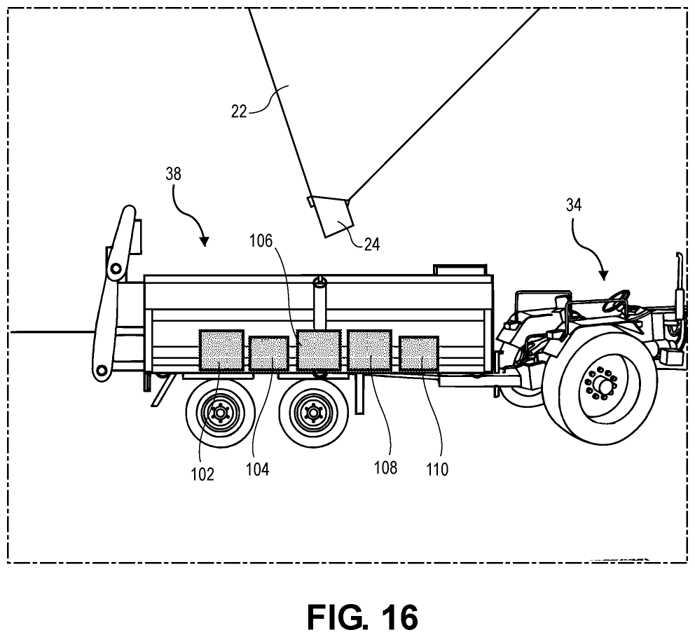

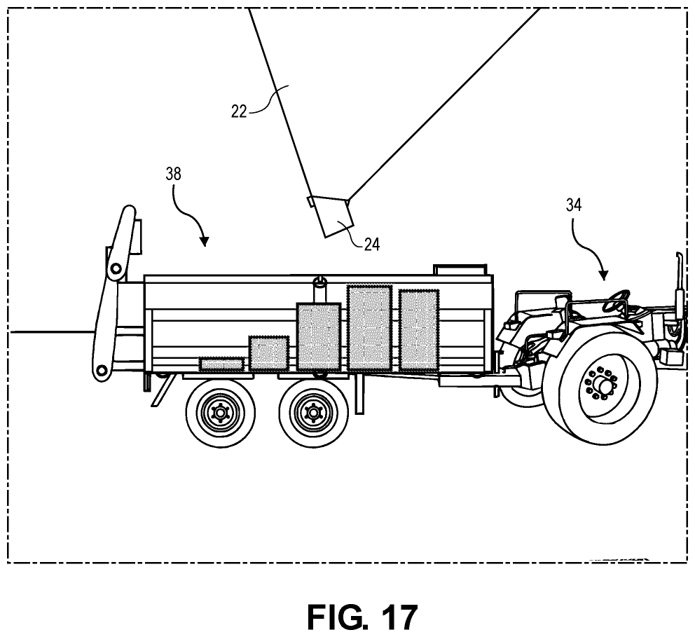

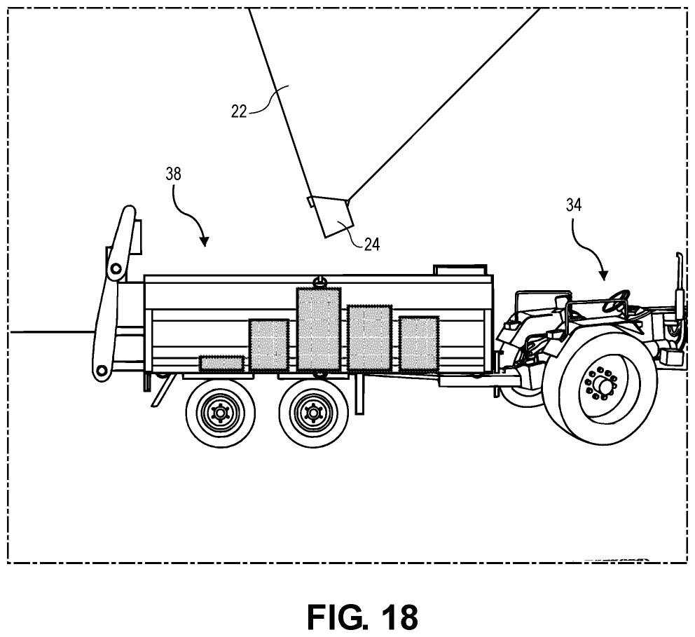

FIGS. 16 through 18 depict another embodiment wherein the graphical marker includes a plurality of bars 102, 104, 106, 108 and 110 superimposed over the graphical depiction of the receiving vehicle, wherein a height of each of the plurality of bars 102, 104, 106, 108 and 110 indicates the fill level of the receiving vehicle at a different location in the receiving vehicle. In this embodiment the graphical depiction indicates a distribution of the grain inside the cart as well as a fill level. The graphical indicator depicted in FIG. 16, for example, indicates that the grain cart is a little less than half full and that the distribution of grain within the cart is approximately even from front to back. The graphical indicator depicted in FIG. 17 indicates that the grain is more heavily distributed toward the front of the grain cart. The graphical indicator depicted in FIG. 17 corresponds to the data illustrated in FIG. 12. This would indicate to the operator that the grain cart should be moved forward relative to the agricultural harvester to fill the rearward portion of the grain cart. The graphical indicator depicted in FIG. 18 indicates that the grain is more heavily distributed in the middle of the grain cart and that the front and rear portions of the grain cart have less grain. In other words, the grain is heaped up in the middle of the cart.

In the graphical depictions set forth in FIGS. 16 through 18 image data from the camera is used such that the receiving vehicle presented via the graphical user interface is identical in appearance to the actual receiving vehicle. This makes it easier, for example, for the operator to associate fill bars with actual locations of the receiving vehicle. The unload conveyor 22 is also depicted in the image which provides a visual indication to the operator of the alignment of the unload conveyor 22 with the grain cart 36. Thus, the graphical indicator presented on the graphical user interface enables the operator to see the grain cart, the fill level and/or distribution of crop in the grain cart and the unload conveyor 22 from the vantage point of the side of the harvester nearest the receiving vehicle and beneath the unload conveyor. The view of the receiving vehicle, presented as a side elevation, along with the unload conveyor and the graphical marker superimposed over the side elevation view of the receiving vehicle makes it very quick and easy for the operator to determine not only the fill level and/or distribution of the grain cart but also the alignment of the unload conveyor and the receiving vehicle.

During a harvest operation, the controller 46 continuously or periodically receives image data from the camera 28 and uses the image data to detect the presence of the markers 70, 72 by detecting the patterns associated with each marker. Once the controller 46 has identified the markers 70, 72, it determines the location of the receiving vehicle relative to the harvester 10 using the size and location of the markers 70, 72 as explained above. The controller 46 may also use the size and location of the markers 70, 72 to determine the size of the receiving vehicle, the orientation of the receiving vehicle relative to the harvester 10, or both. The controller 46 also collects and communicates image data of the receiving vehicle to the portable electronic device 50 for presentation as part of the graphical user interface, as explained above.

The controller 46 also uses data from the electromagnetic detecting and ranging module 32 to determine a fill level, distribution pattern, or both of crop material in the receiving vehicle as explained above. The controller 46 communicates the location information and the crop information to the portable electronic device 50 via the wireless communications link using the transceiver 48.

The portable electronic device 50 uses the data from the electromagnetic detecting and ranging module 32 and the image data from the camera 28 to generate the graphical indicator of the fill level of the receiving vehicle, as explained above.

In addition to illustrating the fill level and/or distribution of crop in the receiving vehicle, the graphical indicator may also illustrate, in an intuitive way, the relative positions of the unload conveyor 22 and the grain bin of the receiving vehicle. The graphic representation is presented on the graphical user interface 52 of the portable electronic device 50, thereby allowing the operator to see the position of the grain bin relative to the unload conveyor and the fill level and/or fill pattern of crop material in the grain bin, and to steer the tractor so that the grain bin of the receiving vehicle is located beneath the spout of the unload conveyor. This relieves the operator(s) of the need to try to look backward to see the position of the unload conveyor while also watching the field ahead of the machine. The graphical representation has the further advantage of enabling the operator(s) to see the relative positions of the machines even in situations with limited visibility outside the operator cabin.

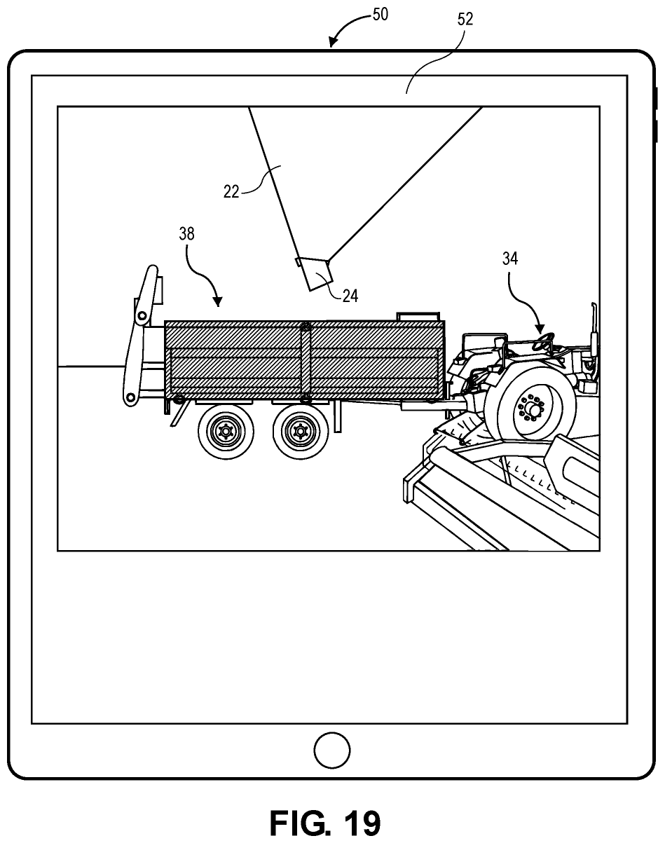

A schematic diagram of certain components of a portable electronic device 200 is illustrated in FIG. 19 and includes one or more computer processors 202, one or more memory and storage components 204, memory and storage controller circuitry 206, peripheral interface circuitry 208 and other hardware/circuitry 210 associated with user interface(s) (for example, a graphical user interface), input/output, sensors and communications (for example, wireless or wired network communications). The memory and storage component 204 stores computer software executable by the processor(s) 202, such as an operating system and applications, as well as data. The memory and storage controller 206 controls access to and communication with the memory 204 by the processor(s) 202 and the peripheral interface 208. When a software application is installed or run on the portable electronic device 200 the executable computer instructions, as well as the data, associated with the app are stored in the storage and memory components and executed by the processor(s). The processor(s) 202, the peripheral interface 208 and/or the hardware and circuitry 210 associated with the interface, I/O, sensors and communications enable a human-machine interface such as a touchscreen through which a user interacts with the device. The processor(s) 202, the peripheral interface 208 and/or the hardware and circuitry 210 associated with the interface, I/O, sensors and communications also enable communications with an external communications or computer network or with an external machine, such as the harvester 10.

In another embodiment of the invention the controller 46 uses image data generated by the camera 28 to identify the receiving vehicle within the field of view of the camera without the use of fiducial markers, such has markers 70-80 described above. In this embodiment, the system 44 includes software with one or more machine learning algorithms for determining whether an image includes a depiction of a receiving vehicle. The machine learning algorithms are trained to identify the receiving vehicle as well as portions of the receiving vehicle, as explained below. If the image captured by the camera 28 includes a receiving vehicle, the controller 46 identifies a portion of the receiving vehicle that receives the grain (or other crop material), such as the grain bin 38.

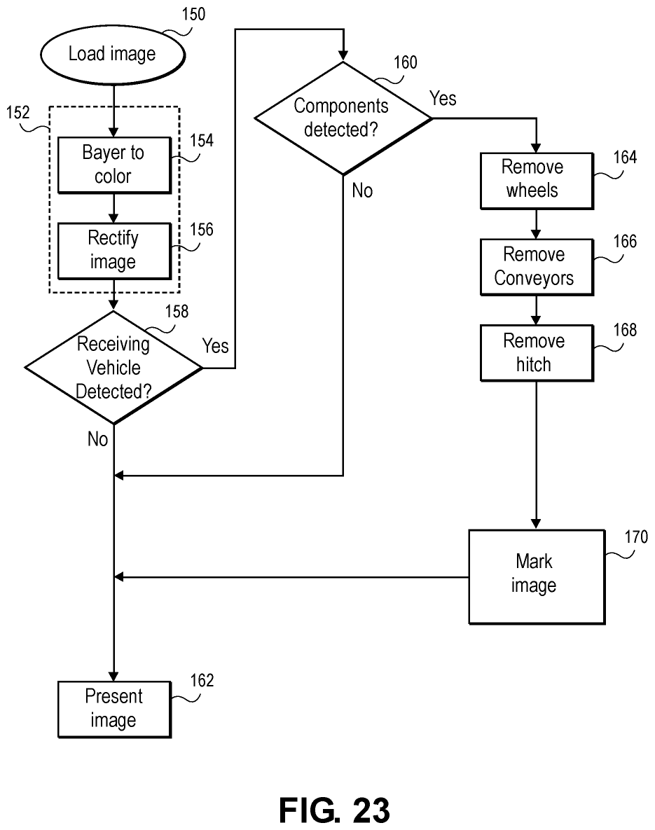

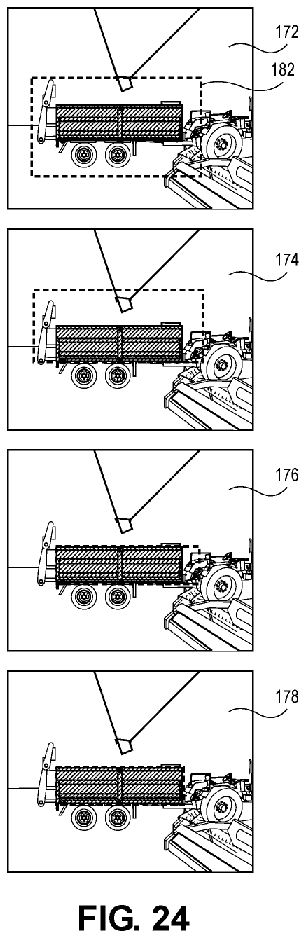

FIG. 23 is a flow diagram illustrating a method of identifying the grain cart 36 and the grain bin 38 of the grain cart 36 in an image or video captured by the camera 28. In step 150 the image is loaded by the controller for processing. Image preparation steps 152 may include converting a Bayer pattern into a color image, as depicted in block 154, and rectifying the image, as depicted in block 156. Once the image has been prepared a machine learning algorithm is applied to determine whether the image contains a receiving vehicle, as depicted in block 158. Image 172 in FIG. 24 illustrates an area of interest 182 within the image 172 identified by the controller as containing the grain cart 36.

After the controller detects the presence of the grain cart in the image it then identifies the grain bin 38 of the grain cart 36 by identifying and excluding from the area of interest various components of the grain cart 36. The controller uses one or more machine learning algorithms to attempt to identify wheels, an unload auger and a hitch of the grain cart 36 in the image, as depicted in block 160. If the controller cannot identify the components in the image then the image is probably not a receiving vehicle and the controller presents the image to the operator without marking the image, as depicted in block 162.

If the controller identifies the components in step 160, it adjusts the area of interest 182 to exclude those components, as depicted in blocks 164, 166 and 168. Adjusting the area of interest 182 to exclude the wheels results in an area of interest as depicted in image 174 of FIG. 24. Adjusting the area of interest to exclude the unload conveyors of the combine and the grain cart results in an area of interest as depicted in image 176 of FIG. 24. Adjusting the area of interest to exclude the hitch results in an area of interest as depicted in image 178 of FIG. 24. With those components of the grain cart identified and excluded, the resulting area of interest corresponds to the grain bin 38 of the grain cart 36. With the grain bin 38 identified in the image the controller may mark the area of the image corresponding to the grain bin, as depicted in block 170, prior to presenting the image on the user interface. The step of marking depicted in block 170 may include adding one or more of the bars 100-110, as described above, or highlighting portions of the image as illustrated in FIGS. 19-21 and described below. Once the image has been marked it is presented to the operator, as depicted in block 162.

As indicated above, the software includes one or more machine learning algorithms for determining whether image data includes a depiction of a receiving vehicle and, if so, attributes about the receiving vehicle. As used herein, a machine learning algorithm is an algorithm that enables a computer to learn from experience. The concept of experience in this regard is typically represented as a dataset of historic events, and learning involves identifying and extracting useful patterns from such a dataset. A machine learning algorithm takes a dataset as input and returns a model that encodes the patterns the algorithm extracted (or “learned”) from the data.

The controller uses the machine learning algorithm to learn to identify receiving vehicles depicted in images captured by the camera 28 by analyzing many different images of different types of receiving vehicles, including different models of grain carts. This process may involve analyzing thousands, tens of thousands or hundreds of thousands of images and developing a model that takes as an input an image of a receiving vehicle captured by the camera 28 and returns values indicating a particular type of receiving vehicle. As explained below, dimensions such as length and height for each type of receiving vehicle are known and matched to the particular receiving vehicle identified by the model. The one or more computing devices use the actual dimensions of the receiving vehicle, the size of the receiving vehicle in the image and the position of the receiving vehicle in the image to determine a location of the receiving vehicle relative to the harvester 10.

The one or more machine learning algorithms preferably include a deep learning algorithm and, in particular, a deep learning algorithm involving a convolutional neural network. Convolutional neural networks are a class of deep learning neural networks well-suited for analyzing image data. A convolutional neural network includes an input layer, an output layer and a number of hidden layers. The hidden layers of a convolutional neural network typically consist of a series of convolutional layers that convolve with a multiplication or other dot product. The activation function is commonly a rectifier linear unit layer, and is subsequently followed by additional convolutions such as pooling layers, fully connected layers and normalization layers, referred to as hidden layers because their inputs and outputs are masked by the activation function and final convolution.

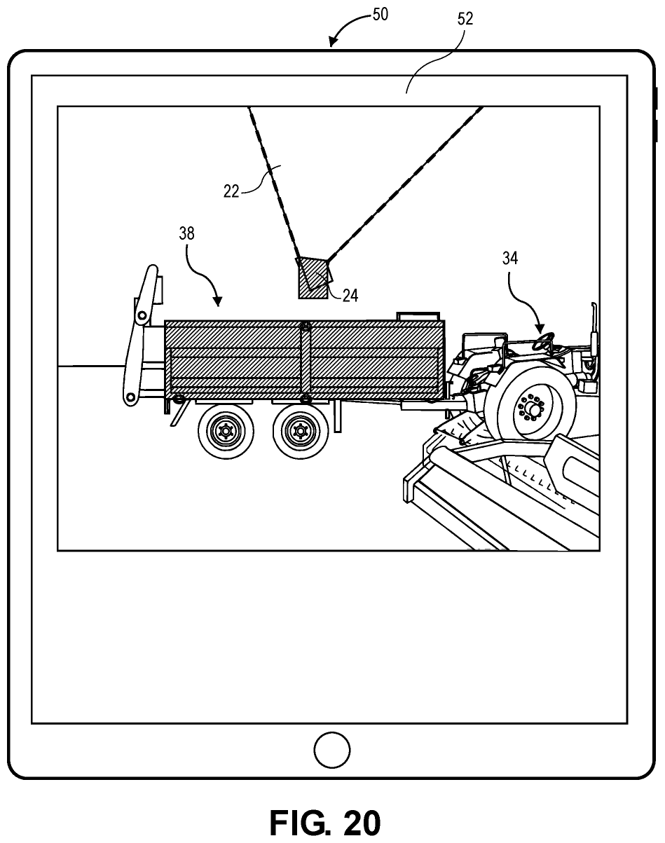

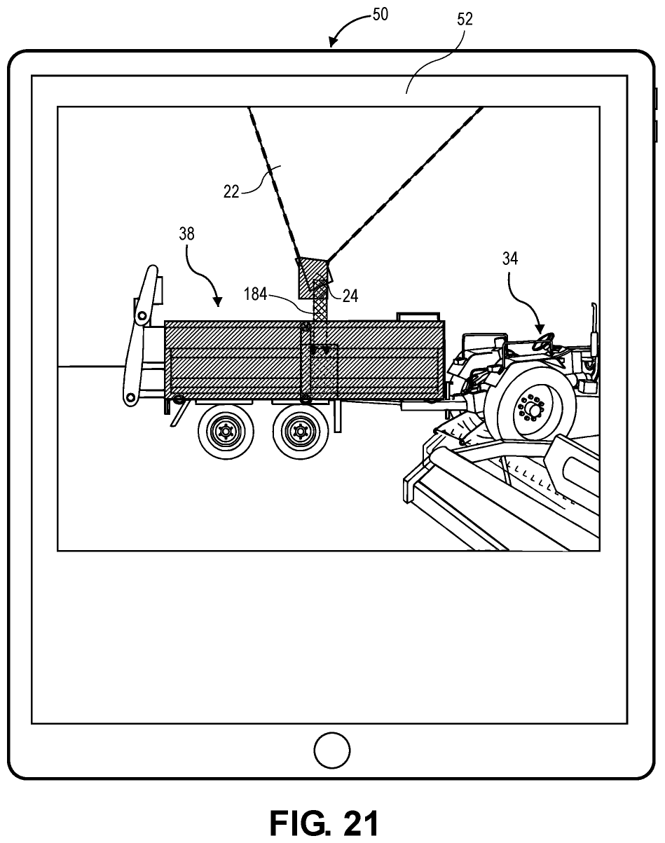

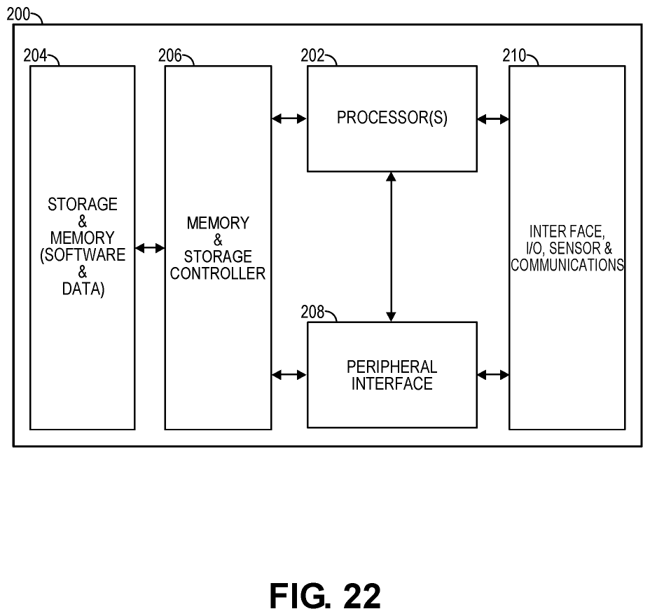

Another embodiment of the invention is illustrated in FIGS. 19 through 21. In this embodiment, portions of the receiving vehicle, the agricultural harvester, or both are highlighted or otherwise visually indicated in the graphical user interface. As illustrated in FIG. 19, for example, the portion of the grain cart 36 corresponding to the grain bin 38 is presented in a different shade. This functionality makes it easier for the user to identify the location of the grain bin in the image. In the implementation illustrated in FIG. 20, a portion of the grain cart 36 corresponding to the grain bin 38 and the spout 24 of the unload conveyor 22 are both highlighted or otherwise visually indicated. In the implementation illustrated in FIG. 21, a portion of the grain cart 36 corresponding to the grain bin 38, the spout 24 of the unload conveyor 22, and a stream of crop 184 between the spout 24 and the grain cart 36 are all highlighted or otherwise visually indicated.

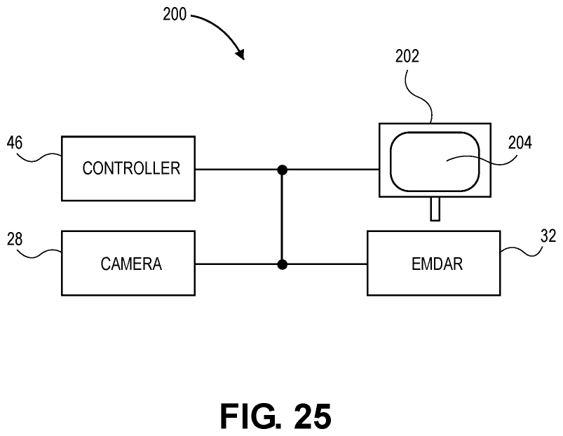

Another embodiment of the invention includes an unload synchronization assistance system 200 that includes a wired connection to a console 202 with a graphical user interface 204 as illustrated in FIG. 25. The console 202 may be fixed in the operator cabin 26 for, example, of the agricultural harvester 10.

Although the invention has been described with reference to the preferred embodiment illustrated in the attached drawing figures, it is noted that equivalents may be employed and substitutions made herein without departing from the scope of the invention as recited in the claims.

The claims at the end of this patent application are not intended to be construed under 35 U.S.C. § 112(f) unless traditional means-plus-function language is expressly recited, such as “means for” or “step for” language being explicitly recited in the claim(s).

Having thus described the preferred embodiment of the invention, what is claimed as new and desired to be protected by Letters Patent includes the following:

1. A system comprising:
an agricultural harvester including—
a crop processor for reducing crop material to processed crop, and
an unload conveyor for transferring processed crop out of the agricultural harvester;
one or more sensors for generating data indicating a fill level of processed crop within the grain bin of a receiving vehicle proximate the agricultural harvester;
a camera positioned to capture images of the receiving vehicle and configured to generate image data, the image data including image data of at least a portion of the receiving vehicle,
a controller for—
receiving the data from the one or more sensors,
determining, using the data from the one or more sensors, the fill level of the processed crop in the grain bin of the receiving vehicle,
receiving the image data from the camera,
generating a graphical indicator corresponding to the receiving vehicle, the graphical indicator including a graphical depiction of the receiving vehicle from the image data and a graphical marker superimposed over at least a portion of the graphical depiction of the receiving vehicle; and
a graphical user interface in communication with the controller, the graphical user interface configured to present the graphical indicator of the fill level to a user.

2. The system as set forth in claim 1, the graphical marker including a bar superimposed over the graphical depiction of the receiving vehicle, a height of the bar indicating the fill level of the receiving vehicle.

3. The system as set forth in claim 1, the graphical marker including a plurality of bars superimposed over the graphical depiction of the receiving vehicle, wherein a height of each of the plurality of bars indicates the fill level of the receiving vehicle at a different location in the receiving vehicle.

4. The system as set forth in claim 1, the graphical marker including a visual indicator of at least one of a grain bin of the receiving vehicle, an unload conveyor of the agricultural harvester, and a stream of crop flowing between the agricultural harvester and the receiving vehicle.

5. The system as set forth in claim 1, the one or more sensors including an electromagnetic detecting and ranging module.

6. The system as set forth in claim 1, the controller further configured to—
identify the receiving vehicle from the image data using a machine learning algorithm, and
identify a grain bin of the receiving vehicle using a machine learning algorithm.

7. The system as set forth in claim 1, the controller further configured to—
identify, from the image data, a predetermined visual marker corresponding to the receiving vehicle, and
determine, from the visual marker, a location of the receiving vehicle relative to the agricultural harvester.

8. The system as set forth in claim 1, the graphical depiction of the receiving vehicle from the image data including a side elevation view of the receiving vehicle, the graphical marker being depicted on a side of the receiving vehicle in the side elevation view.

9. The system as set forth in claim 1,
the image data generated by the camera further including image data of at least a portion of an unload conveyor of the agricultural harvester, and
the graphical indicator generated by the controller further including a depiction of at least a portion of the unload conveyor such that the graphical indicator includes the graphical depiction of the receiving vehicle from the image data, the graphical marker superimposed over at least a portion of the graphical depiction of the receiving vehicle, and the depiction of at least a portion of the unload conveyor.

10. A method comprising—
using one or more sensors to generate data indicating a fill level of processed crop within a grain bin of a receiving vehicle proximate an agricultural harvester, the agricultural harvester including a crop processor for reducing crop material to processed crop and an unload conveyor for transferring processed crop out of the agricultural harvester;
using a camera to generate image data, the image data including image data of at least a portion of the receiving vehicle;
using a controller to determine, using the data from the one or more sensors, the fill level of the processed crop in the grain bin of the receiving vehicle;
using the controller to generate a graphical indicator of the fill level, the graphical indicator including a graphical depiction of the receiving vehicle from the image data and a graphical marker superimposed over at least a portion of the graphical depiction of the receiving vehicle; and
presenting the graphical indicator of the fill level on a graphical user interface, the graphical user interface being in communication with the controller and receiving the graphical indicator from the controller.

11. The method of claim 10, the step of using the controller to generate the graphical indicator of the fill level including generating the graphical indicator such that it includes a bar superimposed over the graphical depiction of the receiving vehicle, wherein the height of the bar indicates the fill level of the receiving vehicle.

12. The method of claim 10, the step of using the controller to generate the graphical indicator of the fill level including generating the graphical indicator such that it includes a plurality of bars superimposed over the graphical depiction of the receiving vehicle, wherein the height of each of the plurality of bars indicates the fill level of the receiving vehicle at a different location in the receiving vehicle.

13. The method as set forth in claim 10, the step of using one or more sensors to generate data indicating a fill level of processed crop within the grain bin of the receiving vehicle including using an electromagnetic detecting and ranging module positioned so that a field of view of the module extends at least partially into the grain bin.

14. The method as set forth in claim 10,
the image data generated by the camera further including image data of at least a portion of an unload conveyor of the agricultural harvester, and
the graphical indicator generated by the controller further including a depiction of at least a portion of the unload conveyor such that the graphical indicator includes the graphical depiction of the receiving vehicle from the image data, the graphical marker superimposed over at least a portion of the graphical depiction of the receiving vehicle, and the depiction of at least a portion of the unload conveyor.

15. A system comprising:
an agricultural harvester including—
a crop processor for reducing crop material to processed crop, and
an unload conveyor for transferring processed crop out of the agricultural harvester;
a receiving vehicle including a grain bin for receiving the processed crop from the unload conveyor of the agricultural harvester;
one or more sensors for generating data indicating a fill level of processed crop within the grain bin of a receiving vehicle proximate the agricultural harvester;
a controller for—
receiving the data from the one or more sensors,
determining, using the data from the one or more sensors, the fill level of the processed crop in the grain bin of the receiving vehicle, and
generating a graphical indicator of the fill level, the graphical indicator including a graphical depiction of the receiving vehicle and a graphical marker superimposed over at least a portion of the graphical depiction of the receiving vehicle; and
a graphical user interface in communication with the controller, the graphical user interface configured to present the graphical indicator of the fill level to a user.

16. The system as set forth in claim 15, the one or more sensors including an electromagnetic detecting and ranging module attached to the receiving vehicle.

17. The system as set forth in claim 15, the one or more sensors including an electromagnetic detecting and ranging module attached to the agricultural harvester.

18. The system as set forth in claim 15, the one or more sensors including a sensor selected a radio detecting and ranging module.

19. The system as set forth in claim 15, the one or more sensors including at least one contact sensor inside the grain bin of the receiving vehicle.

20. The system as set forth in claim 15, further comprising—
a camera positioned to capture images of the receiving vehicle and configured to generate image data, the image data including image data of at least a portion of the receiving vehicle,
wherein the controller is further configured to—
receive the image data from the camera, and
use the image data from the camera to generate the graphical depiction of the receiving vehicle.
